(19) United States
(12) Patent Application Publication
(10) Pub. No.: US 2026/0316699 A1
(43) Pub. Date: Oct. 15, 2026

(54) WIRE HARNESS AND PROTECTOR

(71) Applicant: Yazaki Corporation, Tokyo (JP)

(72) Inventors: Tetsuo NOHARA, Tochigi (JP); Hiroyuki Nishi, Tochigi (JP)

(73) Assignee: Yazaki Corporation, Tokyo (JP)

(21) Appl. No.: 19/369,575

(22) Filed: Oct. 27, 2025

(30) Foreign Application Priority Data
Oct. 30, 2024 (JP) 2024-190452

(51) Int. Cl. B60R 16/02; H02G 3/04

(52) U.S. Cl. CPC B60R 16/0215; H02G 3/045; H02G 3/0456

(57) ABSTRACT

A wire harness includes a routing member and a protector, and the protector includes a body part into which the routing member is inserted along an inserting direction. Furthermore, the body part includes a bottom wall, a pair of standing walls, an accommodating space inside which the routing member is inserted, a tape-wrapped portion to which the routing member is fixed by wrapping a tape, and a protective wall portion configured so that heights of the standing walls are high in comparison with the standing walls in the tape-wrapped portion. Furthermore, the heights of the standing walls in the protective wall portion are configured to be higher than a movable height of the routing member generated by bending of the routing member in the protective wall portion with the routing member accommodated in the accommodating space and fixed to the tape-wrapped portion with the tape.

### CROSS-REFERENCE TO RELATED APPLICATION(S)

The present application claims priority to and incorporates by reference the entire contents of Japanese Patent Application No. 2024-190452 filed in Japan on Oct. 30, 2024.

### BACKGROUND OF THE INVENTION

### 1. Field of the Invention

The present invention relates to a wire harness and a protector.

### 2. Description of the Related Art

For example, in Japanese Patent Application Laid-open No. JP 2002-225 648 A, a protector for a wire harness is disclosed that includes gutter-shaped protector bodies (body parts) and electric wire fixing bars capable of being closed across openings of the protector bodies.

Now, the above protector for a wire harness described in Japanese Patent Application Laid-open No. JP 2002-225 648 A can prevent a routing member accommodated in the body parts from coming out by using the electric wire fixing bars; however, if a structure or a member for preventing the routing member from coming out is newly prepared, the product may become larger than necessary or cost too much. Thus, there is room for further improvement in terms of properly routing the routing member by a simpler method.

### SUMMARY OF THE INVENTION

In light of the foregoing, an object of the present invention is to provide a wire harness and a protector that can properly route a routing member.

In order to achieve the above mentioned object, a wire harness according to one aspect of the present invention includes a routing member having conductivity; and a protector disposed at the routing member, wherein the protector includes a body part, the routing member being inserted into the body part along an inserting direction, the body part including an inserting opening opening in the inserting direction, the body part includes a bottom wall, a pair of standing walls, and an accommodating space, the bottom wall extending along the inserting direction, the pair of standing walls being disposed on both sides across the bottom wall and being formed protruding from the bottom wall along a protruding direction intersecting with the inserting direction, the accommodating space being divided and formed by the bottom wall and the pair of standing walls, the routing member being inserted inside the accommodating space, the body part includes a tape-wrapped portion and a protective wall portion, the routing member being fixed to the tape-wrapped portion by wrapping a tape, the protective wall portion being configured so that heights of the standing walls are high in comparison with the standing walls in the tape-wrapped portion, and the heights of the standing walls in the protective wall portion is configured to be higher than a movable height of the routing member generated by bending of the routing member in the protective wall portion with the routing member accommodated in the accommodating space and fixed to the tape-wrapped portion with the tape.

In order to achieve the above mentioned object, a protector according to another aspect of the present invention includes a body part including an inserting opening, a routing member being inserted into the body part along an inserting direction, the inserting opening opening in the inserting direction, the routing member having conductivity, the body part including a bottom wall, a pair of standing walls, and an accommodating space, the bottom wall extending along the inserting direction, the pair of standing walls being disposed on both sides across the bottom wall and being formed protruding from the bottom wall along a protruding direction intersecting with the inserting direction, the accommodating space being divided and formed by the bottom wall and the pair of standing walls, the routing member being inserted inside the accommodating space, wherein the body part includes a tape-wrapped portion and a protective wall portion, the routing member being fixed to the tape-wrapped portion by wrapping a tape, the protective wall portion being configured so that heights of the standing walls are high in comparison with the standing walls in the tape-wrapped portion, and the heights of the standing walls in the protective wall portion is configured to be higher than a movable height of the routing member generated by bending of the routing member in the protective wall portion with the routing member accommodated in the accommodating space and fixed to the tape-wrapped portion with the tape.

### BRIEF DESCRIPTION OF THE DRAWINGS

FIG. 1 is a diagram illustrating a schematic configuration of a wire harness according to the present embodiment.

FIG. 2 is a perspective view illustrating the schematic configuration of the wire harness according to the present embodiment.

FIG. 3 is a front view illustrating the schematic configuration of the wire harness according to the present embodiment.

FIG. 4 is a plan view illustrating the schematic configuration of the wire harness according to the present embodiment.

FIG. 5 is a side view illustrating the schematic configuration of the wire harness according to the present embodiment.

### DETAILED DESCRIPTION OF THE PREFERRED EMBODIMENTS

An embodiment according to the present invention will be described in detail below with reference to the drawings. Note that this embodiment should not be construed to limit this invention. Constituents in the following embodiment include constituents that can be readily substituted by those skilled in the art or that are substantially the same.

### Embodiment

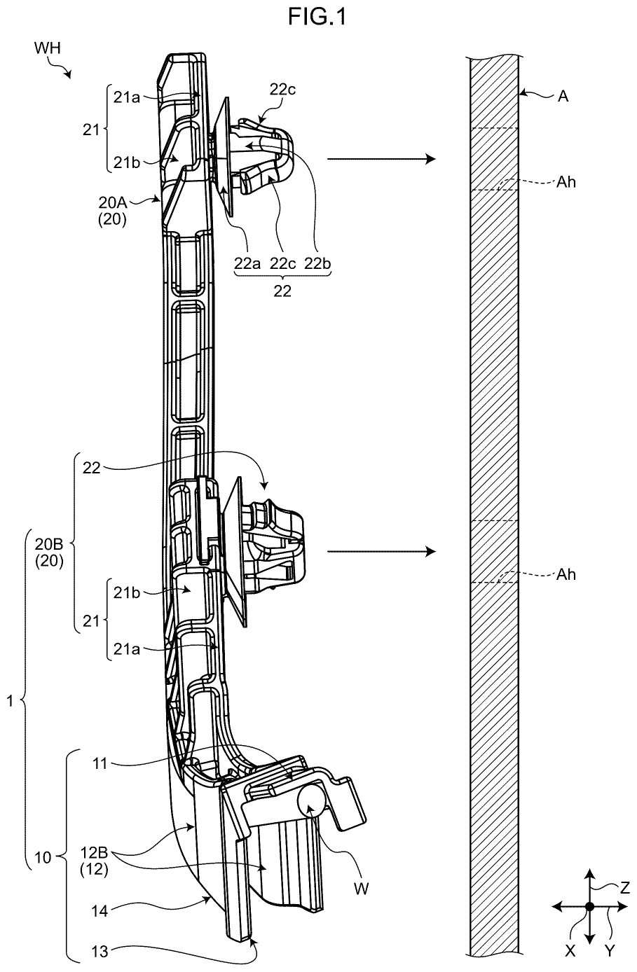

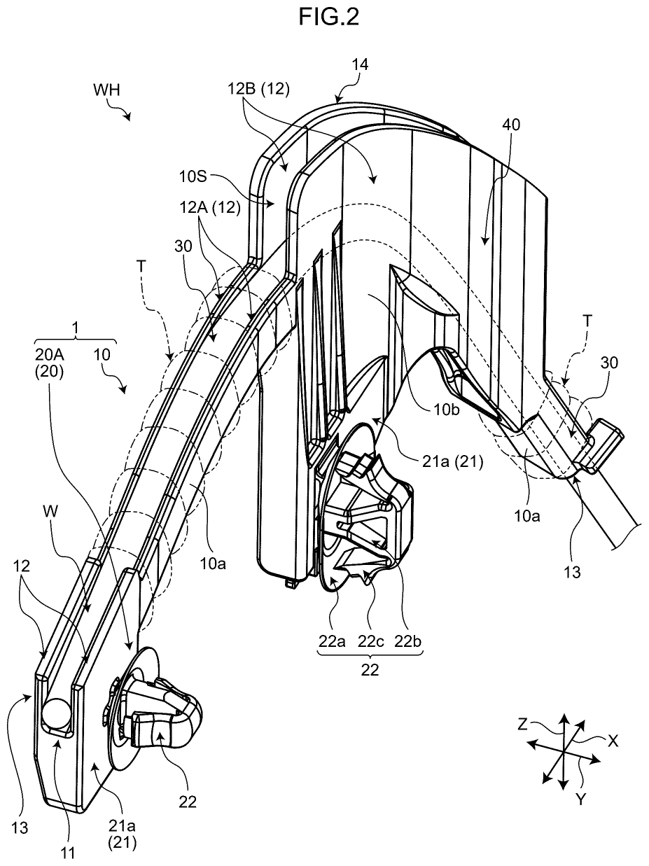

A wire harness WH illustrated in FIGS. 1 and 2 is, for example, for connecting a plurality of routing members W bundled together as an assembled component and used for power supply and signal communication to devices mounted in a vehicle by using connectors and the like to connect the devices to each other.

In the wire harness WH, the routing members W are routed along a preliminarily set routing path, and a protector 1 as an exterior member is assembled to the routing members W as needed. In addition, as illustrated in FIG. 2, by providing tape-wrapped portions 30 where the routing members W are fixed by wrapping tapes T and a protective wall portion 40 having higher side walls (standing walls 12 in the present embodiment) than those of the tape-wrapped portion 30, the protector 1 of the present embodiment enables a configuration that can properly route the routing members W. Each configuration of the wire harness WH and the protector 1 will be described in detail below with reference to FIGS. 1 to 5.

Note that, for convenience of description, the tapes T are omitted in FIG. 1. Furthermore, in FIGS. 2 to 5, the tapes T are illustrated with chain double-dashed lines.

Furthermore, the wire harness WH may include not only these but also a grommet, a fixing tool, a connector, and the like.

Furthermore, in the following description, among a first direction, a second direction, and a third direction that intersect with each other, the first direction is referred to as “length direction X”, the second direction as “width direction Y”, and the third direction as “height direction Z”. Herein, the length direction X, the width direction Y, and the height direction Z are orthogonal to each other. Furthermore, the length direction X typically corresponds to a length direction (long-side direction) of the protector 1 and the like. Furthermore, the width direction Y corresponds to a width direction (short-side direction) of the protector 1 and the like. Furthermore, the height direction Z typically corresponds to a height direction of the protector 1 and the like.

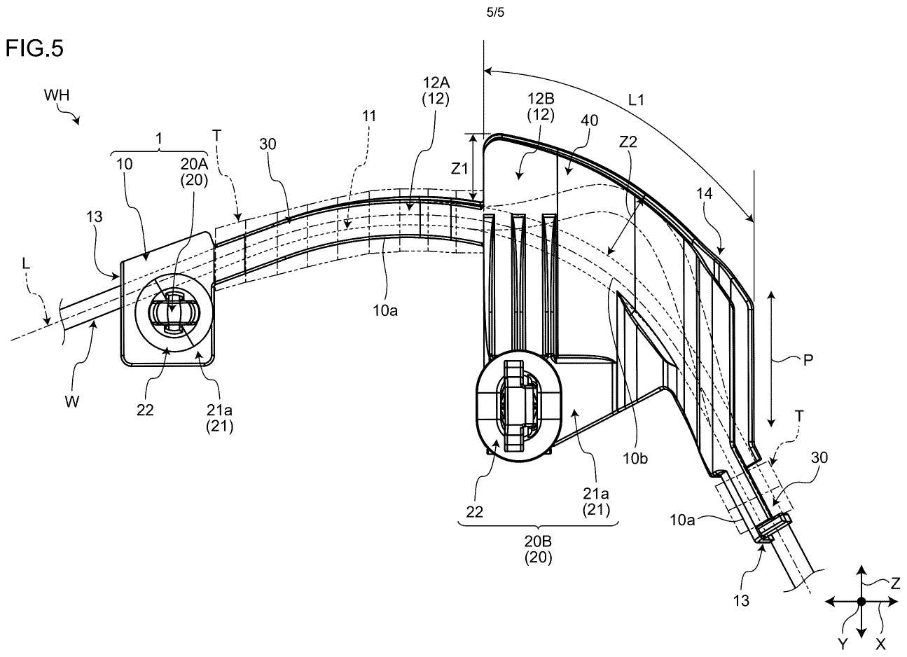

Furthermore, in the following description, the direction of inserting the routing members W into the protector 1 is referred to as “inserting direction L”, and the direction in which the standing walls 12 protrude from a bottom wall 11 extending along the inserting direction L as “protruding direction P”. Herein, the inserting direction L and the protruding direction P intersect with each other (see FIG. 5). Furthermore, the inserting direction L typically corresponds to an extending direction of a body part 10, an axial direction of the routing members W accommodated inside the body part 10, and the like. Furthermore, the protruding direction P typically corresponds to an opening direction of an opening 14 disposed in the body part 10 and the like.

As illustrated in FIG. 1, the wire harness WH includes the routing members W having conductivity and the protector 1 inside which the routing members W are inserted.

### Routing Member

The routing members W are routed in the vehicle and electrically connect each device. The routing members W of the present embodiment are insulation electric wires that include conductors (core wires) having conductivity and insulation coverings having insulation properties and in which the conductors are covered by the insulation coverings. The conductors herein are stranded wires in which a plurality of conductive individual wires are stranded together. Furthermore, the insulation coverings are, for example, formed by extrusion molding of a resin material (PP, PVC, cross-linked PE, or the like, selected appropriately in consideration of abrasion resistance, chemical resistance, thermal resistance, and the like) or the like having insulation properties. Note that the conductors may be bundles of a plurality of individual wires.

Furthermore, the routing members W have a substantially circular sectional shape as a whole while the sectional shape (sectional shape in a direction intersecting with the extending direction of the routing members W) of the conductors is substantially circular and the sectional shape of the insulation coverings is substantially ring-like.

### Protector

The protector 1 is formed from a resin material or the like having insulation properties and protects the routing members W inserted inside. The protector 1 is used as a member restricting the routing path of the routing members W when fixed to the vehicle. As illustrated in FIG. 1, the protector 1 includes the body part 10 and fixed parts 20 enabling the body part 10 to be fixed to a fixing target site A. Note that the fixing target site A herein is, for example, the body of the vehicle or the like.

The body part 10 is a portion accommodating the routing members W inside. As illustrated in FIG. 1, the body part 10 of the present embodiment includes the bottom wall 11 and a pair of the standing walls 12 disposed on both sides across the bottom wall 11, and the sectional shape along the inserting direction L is formed to be U-shaped by integrally forming the bottom wall 11 and the pair of standing walls 12.

The bottom wall 11 is a plate-like wall extending along the inserting direction L and the width direction Y with the protruding direction P being the plate thickness direction. As illustrated in FIG. 2, the bottom wall 11 is located between the pair of standing walls 12 relative to the width direction Y, and both ends are connected to each standing wall 12. Furthermore, the bottom wall 11 has one end in the width direction Y from which one of the standing walls 12 is provided in a standing manner along the protruding direction P and the other end in the width direction Y from which the other standing wall 12 is provided in a standing manner along the protruding direction P. Furthermore, the bottom wall 11 extends from one end of each standing wall 12 in the inserting direction L to the other end. Furthermore, the bottom wall 11 is arranged at an interval from and located opposite the opening 14, described later, along the protruding direction P being the opening direction of the opening 14. Furthermore, in the present embodiment, as illustrated in FIGS. 2 and 5, the bottom wall 11 is formed in accordance with the shapes of straight portions 10a and a curved portion 10b, described later, of the body part 10. Thus, the bottom wall 11 is formed while being curved along the inserting direction L being the extending direction of the body part 10.

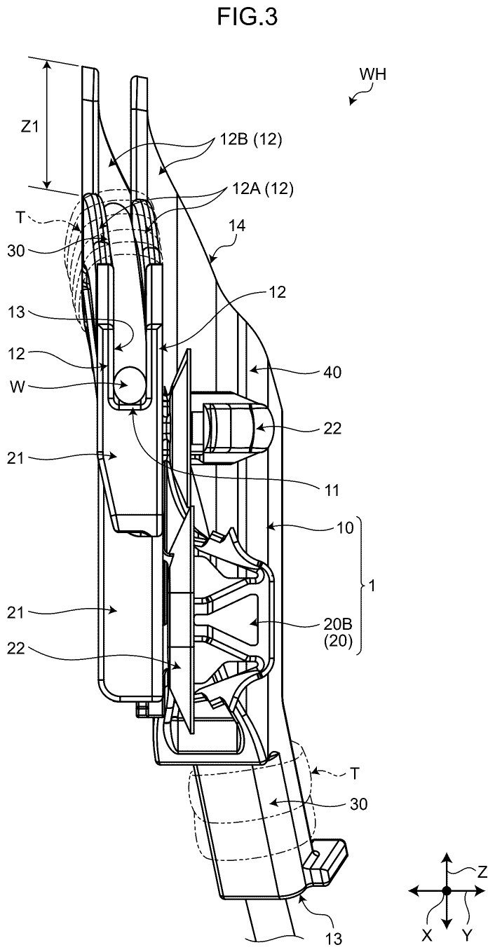

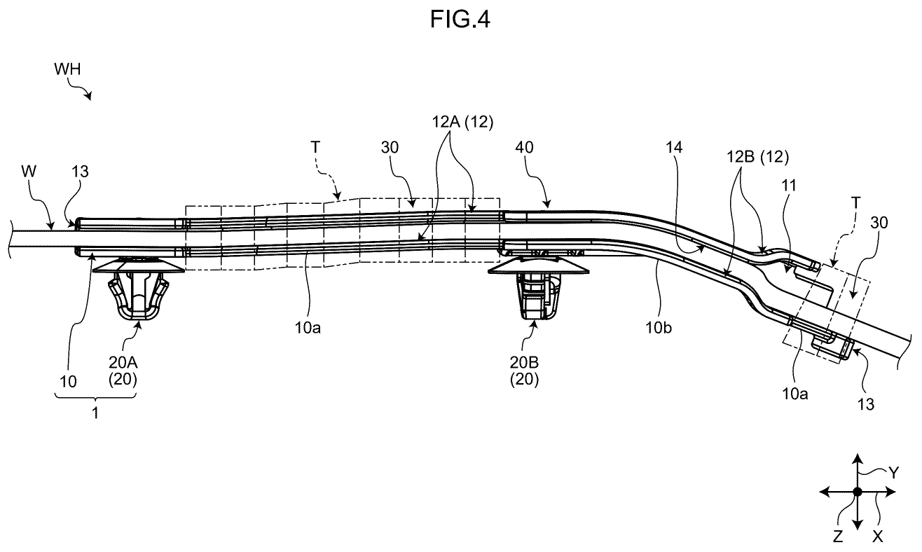

The paired standing walls 12 are plate-like walls extending along the inserting direction L and the protruding direction P with the width direction Y being the plate thickness direction. As illustrated in FIG. 2, the paired standing walls 12 are flat-plate-like and provided straight in a standing manner along the protruding direction P when viewed from the length direction X. Furthermore, as illustrated in FIG. 5, the paired standing walls 12 are formed so that the lengths along the inserting direction L and the lengths along the protruding direction P are substantially equal. Furthermore, as illustrated in FIGS. 2 and 3, in the paired standing walls 12, ends (base ends) on one side in the protruding direction P are connected to the bottom wall 11, and ends (tips) on the other side in the protruding direction P form the opening 14, described later. Furthermore, the paired standing walls 12 are formed so that the bottom wall 11 protrudes from the ends on the one side in the protruding direction P along the width direction Y. Furthermore, as illustrated in FIG. 4, the paired standing walls 12 extend from one end of the bottom wall 11 in the inserting direction L to the other end. Thus, the paired standing walls 12 of the present embodiment are each formed protruding from both ends of the bottom wall 11 in the width direction Y along the protruding direction P. Note that, in the following description, to distinguish between the standing walls 12 in the tape-wrapped portion 30, described later, and the standing walls 12 in the protective wall portion 40, described later, the standing walls 12 in the tape-wrapped portion 30 may be referred to as “standing walls 12A”, and the standing walls 12 in the protective wall portion 40 as “standing walls 12B”.

Furthermore, as illustrated in FIG. 2, the body part 10 includes an accommodating space 10S as an interior space, a pair of inserting openings 13 opening in the inserting direction L, and the opening 14 opening in the protruding direction P. The accommodating space 10S herein is a portion divided and formed by the bottom wall 11 and the pair of standing walls 12. Furthermore, the inserting openings 13 are portions divided and formed by the bottom wall 11 and the pair of standing walls 12 and portions surrounded on three sides by the ends of the bottom wall 11 in the inserting direction L and the ends of the pair of standing walls 12 in the inserting direction L. Furthermore, the opening 14 is a portion divided and formed by the pair of standing walls 12 and a portion sandwiched between ends located on a side opposite to a side where the bottom wall 11 is located in the protruding direction P. Thus, by inserting the routing members W into the accommodating space 10S via the pair of inserting openings 13 disposed on both ends of the body part 10 in the inserting direction L, the protector 1 of the present embodiment enables the routing members W to be routed along the inserting direction L.

The fixed parts 20 are portions fixed to the fixing target site A. As illustrated in FIGS. 1, 2, and 5, the fixed parts 20 of the present embodiment are provided in a pair, and each fixed part 20 is formed on the bottom side (bottom wall 11 side) of the body part 10. Note that, in the following description, the two fixed parts 20 may be referred to as “fixed part 20A” and “fixed part 20B” when distinguished from each other, and simply as “fixed part 20” when no particular distinction between them is necessary.

As illustrated in FIGS. 1, 2, and 5, the fixed parts 20 include fixed walls 21 and clips 22. Furthermore, the fixed part 20A is disposed at an end of the body part 10 in the inserting direction L, and the fixed part 20B is arranged at an interval from the fixed part 20A in the inserting direction L to be disposed in an intermediate portion of the body part 10.

The fixed walls 21 are walls disposed protruding from the body part 10. As illustrated in FIGS. 1, 2, and 5, the fixed walls 21 are provided in a pair by providing one for each of the fixed part 20A and the fixed part 20B. Furthermore, as illustrated in FIG. 1, the fixed walls 21 each include a plate-like wall 21a provided in a standing manner from the bottom wall 11 of the body part 10 and a plurality of ribs 21b provided in a standing manner from the wall 21a, and the wall 21a and each of the ribs 21b are formed integrally. Note that, herein, the wall 21a is a plate-like wall extending along the inserting direction L and the protruding direction P with the width direction Y being the plate thickness direction, and the ribs 21b are plate-like walls extending in the width direction Y and the protruding direction P with the inserting direction L being the plate thickness direction. As illustrated in FIG. 2, the fixed walls 21 configured in this way are provided protruding on a side opposite to a side having the standing walls 12 relative to the bottom wall 11 and are formed protruding from the bottom wall 11 along the protruding direction P. Furthermore, as illustrated in FIG. 2, the fixed walls 21 are formed so that the thicknesses (the lengths in the width direction Y) are substantially equal to the length of the bottom wall 11 in the width direction Y.

The clips 22 are portions engaged with edges of fixing holes Ah of the fixing target site A when the fixed parts 20 are fixed to the fixing target site A. As illustrated in FIGS. 1, 2, and 5, the clips 22 are provided in a pair by providing one for each of the fixed part 20A and the fixed part 20B. Furthermore, as illustrated in FIGS. 2 and 5, the clips 22 are disposed on surfaces (faces extending along the inserting direction L and the protruding direction P) of the walls 21a composing the fixed walls 21. Furthermore, as illustrated in FIGS. 1 and 2, the clips 22 each include a hood portion 22a, a shaft portion 22b, and a pair of arm portions 22c supported by the shaft portion 22b in a cantilevered manner. Thus, if the clips 22 of the present embodiment are inserted into the fixing holes Ah of the fixing target site A, the hood portions 22a are located in positions where the fixing holes Ah are covered, and the pairs of arm portions 22c bent inward in accordance with the shapes of the fixing holes Ah are each engaged with the edge of the fixing hole Ah of the fixing target site A, whereby the clips 22 are fixed to the fixing target site A (see FIG. 1).

Furthermore, the body part 10 configured as described above includes the straight portions 10a and the curved portion 10b. The straight portions 10a herein are portions formed straight along the inserting direction L. Furthermore, the curved portion 10b is a portion formed like a curve and curved in the protruding direction P relative to the straight portions 10a. As illustrated in FIGS. 2 and 5, the straight portions 10a are provided in a pair at an interval in the inserting direction L, and the curved portion 10b is disposed between the pair of straight portions 10a. Furthermore, each straight portion 10a is disposed at each end of the body part 10 in the length direction X, and the curved portion 10b is disposed in an intermediate portion of the body part 10. Furthermore, the curved portion 10b is formed while being curved on a side (fixed part 20 side) opposite to a side having the opening 14 of the body part 10 in the protruding direction P. Thus, as illustrated in FIGS. 2 and 5, by integrally forming the pair of straight portions 10a and the curved portion 10b, the body part 10 of the present embodiment is formed while the shape viewed in the width direction Y is curved like a J-shape. Furthermore, the extending direction of the body part 10 extends while being curved like a J-shape in conformance with the shape of the body part 10. Furthermore, the fixed parts 20 disposed on the body part 10 are disposed on the inner side of the body part 10 formed while being curved like a J-shape.

Furthermore, as illustrated in FIG. 5, in the body part 10, the fixed part 20A is disposed on the straight portion 10a, and the fixed part 20B is disposed on the curved portion 10b. Thus, the protector 1 of the present embodiment can fix each of the end of the body part 10 in the inserting direction L and the curved portion 10b of the body part 10 to the fixing target site A via the pair of fixed parts 20.

Furthermore, the body part 10 includes the tape-wrapped portions 30 and the protective wall portion 40.

The tape-wrapped portions 30 are portions where the routing members W are fixed by wrapping the tapes T. The tape-wrapped portions 30 are disposed in portions where the shape of the protector 1 is not locally enlarged. Thus, as illustrated in FIG. 2, the tape-wrapped portions 30 of the present embodiment are disposed in portions where the fixed parts 20 are not disposed in the body part 10. In addition, as illustrated in FIGS. 2 to 5, the tape-wrapped portion 30 is disposed on each of the paired straight portions 10a. Thus, the tape-wrapped portions 30 are disposed on the straight portion 10a located between the fixed part 20 disposed at the end of the body part 10 in the inserting direction L and the fixed part 20 disposed on the curved portion 10b of the body part 10 and the straight portion 10a disposed at the end where the fixed part 20 is not disposed between both ends of the body part 10 in the inserting direction L, thereby being disposed at an interval in the inserting direction L. In addition, by wrapping the tapes T so as to close the opening 14 of the body part 10, the tape-wrapped portions 30 can prevent the routing members W accommodated in the accommodating space 10S of the body part 10 from coming out. Furthermore, at the same time, the tape-wrapped portions 30 can fix the routing members W to the body part 10 with the wrapped tapes T.

The protective wall portion 40 is a portion configured so that the heights of the standing walls 12B are high in comparison with the standing walls 12A in the tape-wrapped portion 30. The protective wall portion 40 is disposed in a portion where the shape of the protector 1 is locally enlarged, so that the tape T cannot be wrapped. Thus, as illustrated in FIG. 2, the protective wall portion 40 of the present embodiment is disposed in a portion where the fixed part 20 is disposed in the body part 10. Furthermore, as illustrated in FIGS. 2 to 5, the protective wall portion 40 is disposed between the pair of tape-wrapped portions 30 and disposed in the curved portion 10b of the body part 10 where the fixed part 20 is disposed. Furthermore, as illustrated in FIGS. 2 to 5, the protector 1 of the present embodiment is provided with the protective wall portion 40 in the body part 10, so that, while the protector 1 is fixed to the fixing target site A via the fixed parts 20, the opening 14 formed by the pair of standing walls 12 and opening in the protruding direction P is open.

Furthermore, as illustrated in FIG. 5, the heights of the standing walls 12B in the protective wall portion 40 are configured to be higher than a movable height Z2 of the routing members W generated by bending of the routing members W in the protective wall portion 40 with the routing members W accommodated in the accommodating space 10S of the body part 10 and fixed to the tape-wrapped portions 30 with the tapes T. The movable height Z2 of the routing members W herein is a height at which a portion of the routing members W where the tape T cannot restrain moves in the accommodating space 10S of the body part 10 while the routing members W accommodated in the accommodating space 10S of the body part 10 are fixed to the body part 10 with the tapes T in a plurality of points, and, in the present embodiment, indicates the amount by which the routing members W accommodated in the accommodating space 10S of the body part 10 are bent and move toward the opening 14. As illustrated in FIG. 5, the heights of the standing walls 12B are configured to be higher than the diameter of the routing members W and configured to be higher than the movable height Z2 of the routing members W, whereby the protective wall portion 40 of the present embodiment can prevent the routing members W accommodated in the accommodating space 10S of the body part 10 from coming out.

Note that the heights of the standing walls 12B in the protective wall portion 40 can be set in accordance with conditions, such as the shape of the body part 10 and the length of a section where the tape T cannot be wrapped. Furthermore, the ratio of the length of the section where the tape T cannot be wrapped (length L1 of the protective wall portion 40 in the inserting direction L) to a difference Z1 between the standing walls 12A in the tape-wrapped portion 30 and the standing walls 12B in the protective wall portion 40 may be configured to be in the ratio of 3 to 1 to 4 to 1. To be specific, for example, with the length L1 of 50 mm of the protective wall portion 40 in the inserting direction L, the height difference Z1 between the standing walls 12A in the tape-wrapped portion 30 and the standing walls 12B in the protective wall portion 40 can be approximately 13 mm. In this case, while increases in the size and weight of the protector 1 are restrained, the routing members W accommodated in the accommodating space 10S of the body part 10 can reliably be prevented from getting over the standing walls 12B in the protective wall portion 40 and coming out to the outside. Thus, the wire harness WH of the present embodiment can properly route the routing members W to the protector 1.

The wire harness WH described above includes the routing members W having conductivity and the protector 1 disposed at the routing members W, and the protector 1 includes the body part 10 into which the routing members W are inserted along the inserting direction L and that includes the inserting openings 13 opening in the inserting direction L. Furthermore, the body part 10 includes the bottom wall 11 extending along the inserting direction L, the pair of standing walls 12 disposed on both sides across the bottom wall 11 and formed protruding from the bottom wall 11 in the protruding direction P intersecting with the inserting direction L, and the accommodating space 10S that is divided and formed by the bottom wall 11 and the pair of standing walls 12 and inside which the routing members W are inserted, and includes the tape-wrapped portions 30 to which the routing members W are fixed by wrapping the tapes T and the protective wall portion 40 configured so that the heights of the standing walls 12B are high in comparison with the standing walls 12A in the tape-wrapped portion 30. Furthermore, the heights of the standing walls 12B in the protective wall portion 40 are configured to be higher than the movable height Z2 of the routing members W generated by bending of the routing members W in the protective wall portion 40 with the routing members W accommodated in the accommodating space 10S and fixed to the tape-wrapped portions 30 with the tapes T.

With this configuration, by making the heights of the standing walls 12B in the protective wall portion 40 higher than the heights of the standing walls 12A in the tape-wrapped portion 30, the wire harness WH and the protector 1 can prevent the routing members W accommodated in the accommodating space 10S of the body part 10 from getting over the standing walls 12B in the protective wall portion 40 and coming out to the outside. Thus, even without wrapping a tape around the protective wall portion 40 or preparing a member instead of tape wrapping, the wire harness WH and the protector 1 can prevent the routing members W from coming out to the outside. Hence, the wire harness WH and the protector 1 of the present embodiment can properly route the routing members W. Moreover, the wire harness WH can properly route the routing members W and can thus maintain a state where the routing path of the routing members W is restricted by the protector 1 and the protective function of the protector 1 for the routing members W. Furthermore, with this configuration, the protector 1 can be composed of a single component, and there is no need to newly attach an exterior component, such as a corrugated tube and a twist tube, which can lower difficulty in assembling the wire harness WH to the fixing target site A. Thus, without impairing the ease of assembly of the wire harness WH, the problem of coming out of the routing members W accommodated in the body part 10 can be solved. In addition, by composing the protector 1 from a single component, the wire harness WH can reduce the size of the product for space-saving and achieve environment friendliness and cost reduction due to material reduction.

Furthermore, the wire harness WH and the protector 1 described above include the fixed parts 20 that are disposed on the side opposite to the side having the standing walls 12 relative to the bottom wall 11 and that enable the body part 10 to be fixed to the fixing target site A, and the protective wall portion 40 is disposed in the portion where the fixed part 20 is disposed in the body part 10. With this configuration, the wire harness WH and the protector 1 can prevent the routing members W from coming out to the outside from a portion where a tape cannot be wrapped because of interference of the fixed parts 20 in wrapping the tape T. Thus, the wire harness WH of the present embodiment can route the routing members W to the protector 1 in a more proper state.

Furthermore, the tape-wrapped portions 30 of the wire harness WH and the protector 1 described above are provided in a pair at an interval along the inserting direction L, and the protective wall portion 40 is disposed between the pair of tape-wrapped portions 30. With this configuration, by increasing the heights of the standing walls 12B in the protective wall portion 40 located between the pair of tape-wrapped portions 30, the wire harness WH and the protector 1 can prevent the routing members W bent between the tape-wrapped portions 30 from coming out to the outside. Thus, the wire harness WH of the present embodiment can route the routing members W to the protector 1 in a more proper state.

Furthermore, the body part 10 of the wire harness WH and the protector 1 described above includes the straight portions 10a formed straight along the inserting direction L and the curved portion 10b curved in the protruding direction P relative to the straight portions 10a, and the protective wall portion 40 is disposed in the curved portion 10b. With this configuration, even if a tape cannot be wrapped around the curved portion 10b where the routing members W tend to bend and have play, the wire harness WH and the protector 1 can prevent the routing members W accommodated in the accommodating space 10S of the body part 10 from coming out to the outside by increasing the heights of the standing walls 12B in the protective wall portion 40 disposed in the curved portion 10b. Thus, the wire harness WH of the present embodiment can route the routing members W to the protector 1 in a more proper state.

Furthermore, in the body part 10 of the wire harness WH and the protector 1 described above, the opening 14 formed by the pair of standing walls 12 and opening in the protruding direction P is open while the body part 10 is fixed to the fixing target site A via the fixed parts 20. With this configuration, the wire harness WH and the protector 1 can prevent the routing members W accommodated in the accommodating space 10S of the body part 10 from coming out to the outside with a simple structure. Furthermore, the wire harness WH and the protector 1 do not need preparation of a lid member for the body part 10 and can reduce the number of components. Thus, environment friendliness and cost reduction due to material reduction can be achieved.

Note that the wire harness WH and the protector 1 are not limited to the above-described embodiment, and various modifications can be made within the scope of the claims.

For example, such description has been provided that the protective wall portion 40 is disposed in the portion where the fixed part 20 is disposed; however, as long as the protective wall portion 40 is disposed in a portion where the tape T cannot be wrapped because of balance with the shape of the protector 1, its location is not particularly limited.

Furthermore, such description has been provided that the protective wall portion 40 is disposed in the curved portion 10b of the body part 10; however, the protective wall portion 40 may be disposed in the straight portion 10a of the body part 10.

Furthermore, the shapes of the standing walls 12A composing the tape-wrapped portion 30 and the shapes of the standing walls 12B composing the protective wall portion 40 are not limited to the forms illustrated in FIG. 2 and the like.

Furthermore, the wire harness WH and the protector 1 according to the present embodiment may be configured by combining constituents of the above-described embodiment as appropriate.

The wire harness and the protector according to the present embodiment have an effect of enabling the routing members to be properly routed.

While the present invention is described with respect to a specific embodiment for full and clear disclosure, the appended claims are not limited thereto but are to be construed as embodying all modifications and alternative configurations that may be conceived by those skilled in the art within the basic teachings set forth in the present specification.

What is claimed is:

1. A wire harness comprising:
a routing member having conductivity; and
a protector disposed at the routing member, wherein
the protector includes a body part, the routing member being inserted into the body part along an inserting direction, the body part including an inserting opening opening in the inserting direction,
the body part includes a bottom wall, a pair of standing walls, and an accommodating space, the bottom wall extending along the inserting direction, the pair of standing walls being disposed on both sides across the bottom wall and being formed protruding from the bottom wall along a protruding direction intersecting with the inserting direction, the accommodating space being divided and formed by the bottom wall and the pair of standing walls, the routing member being inserted inside the accommodating space,
the body part includes a tape-wrapped portion and a protective wall portion, the routing member being fixed to the tape-wrapped portion by wrapping a tape, the protective wall portion being configured so that heights of the standing walls are high in comparison with the standing walls in the tape-wrapped portion, and
the heights of the standing walls in the protective wall portion is configured to be higher than a movable height of the routing member generated by bending of the routing member in the protective wall portion with the routing member accommodated in the accommodating space and fixed to the tape-wrapped portion with the tape.

2. The wire harness according to claim 1, wherein
the wire harness includes a fixed part disposed on a side opposite to a side having the standing walls relative to the bottom wall, the fixed part enabling the body part to be fixed to a fixing target site, and
the protective wall portion is disposed in a portion where the fixed part is disposed in the body part.

3. The wire harness according to claim 1, wherein
the tape-wrapped portions are provided in a pair at an interval along the inserting direction, and
the protective wall portion is disposed between the pair of tape-wrapped portions.

4. The wire harness according to claim 2, wherein
the tape-wrapped portions are provided in a pair at an interval along the inserting direction, and
the protective wall portion is disposed between the pair of tape-wrapped portions.

5. The wire harness according to claim 1, wherein
the body part includes
a straight portion formed straight along the inserting direction, and
a curved portion curved in the protruding direction relative to the straight portion, and
the protective wall portion is disposed in the curved portion.

6. The wire harness according to claim 2, wherein
the body part includes
a straight portion formed straight along the inserting direction, and
a curved portion curved in the protruding direction relative to the straight portion, and
the protective wall portion is disposed in the curved portion.

7. The wire harness according to claim 2, wherein
in the body part, an opening is open while the body part is fixed to the fixing target site via the fixed part, the opening being formed by the pair of standing walls and opening in the protruding direction.

8. A protector comprising:
a body part including an inserting opening, a routing member being inserted into the body part along an inserting direction, the inserting opening opening in the inserting direction, the routing member having conductivity, wherein
the body part includes a bottom wall, a pair of standing walls, and an accommodating space, the bottom wall extending along the inserting direction, the pair of standing walls being disposed on both sides across the bottom wall and being formed protruding from the bottom wall along a protruding direction intersecting with the inserting direction, the accommodating space being divided and formed by the bottom wall and the pair of standing walls, the routing member being inserted inside the accommodating space,
the body part includes a tape-wrapped portion and a protective wall portion, the routing member being fixed to the tape-wrapped portion by wrapping a tape, the protective wall portion being configured so that heights of the standing walls are high in comparison with the standing walls in the tape-wrapped portion, and
the heights of the standing walls in the protective wall portion is configured to be higher than a movable height of the routing member generated by bending of the routing member in the protective wall portion with the routing member accommodated in the accommodating space and fixed to the tape-wrapped portion with the tape.
